(19) United States
(12) Patent Application Publication
(10) Pub. No.: US 2016/0189749 A1
(43) Pub. Date: Jun. 30, 2016

(54) AUTOMATIC SELECTIVE UPLOAD OF USER FOOTAGE FOR VIDEO EDITING IN THE CLOUD

(71) Applicant: MAGISTO LTD., Nes-Ziona (IL)

(72) Inventors: Alexander Rav-Acha, Rehovot (IL); Oren Boiman, Sunnyvale, CA (US)

(21) Appl. No.: 14/986,222

(22) Filed: Dec. 31, 2015

Related U.S. Application Data
(60) Provisional application No. 62/098,359, filed on Dec. 31, 2014.

(51) Int. Cl. G11B 27/031; G11B 27/11

(52) U.S. Cl. CPC G11B 27/031; G11B 27/11

(57) ABSTRACT

A method for automatic selective upload of user footage to a cloud for video production purposes is provided herein The method may include obtaining user generated media entities at a mobile device; analyzing said media entities to derive metadata related to the content of the media entities automatically selecting a subset of the analyzed media entities based on the derived metadata; uploading said selected subset to a remote server; and using the uploaded subset at the remote server to generate a video production.

### CROSS REFERENCE TO RELATED APPLICATIONS

This application claims the benefit of U.S. Provisional Patent Application No. 62/098,359, filed on Dec. 31, 2014, which is incorporated herein in its entirety.

### FIELD OF THE INVENTION

The present invention relates generally to the field of video editing, and more particularly to video production.

### BACKGROUND OF THE INVENTION

In the last years, there has been an explosion of personal visual information, including both videos and photos. As most people today have smartphones with a digital camera, people can take photos and videos on a daily basis.

In parallel, there is a large increase in cloud-based services, which make use of servers on the cloud, rather than running entirely in the user's personal devices. Such servers can be, for example, cloud-computing servers such as the ones proposed by the Amazon's AWS.

One of the services that may run on the cloud is video-editing, in which a produced edited movie is generated from user footage. In this case, several steps of the processing, such as the analysis or the rendering of the edited movie, may be done on the cloud rather than on the user device. There can be various advantages to editing in the cloud, for example—using strong designated servers, overcoming device fragmentation problems, being compatible across multiple platforms, and the like.

One of the main drawbacks in cloud-based video editing is the need for uploading the user's raw footage (photos and videos) to the cloud, a process which might be time-consuming and expensive due to the large volume of the footage that needs to be uploaded.

### SUMMARY OF THE INVENTION

Some embodiments of the present invention provide a method to reduce the cost and time of the footage being uploaded using automatic selective-uploading. Several ways are described to determine the portions that will be uploaded (and optionally the resolution and quality in which each portion will be uploaded).

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram illustrating non-limiting exemplary architecture of a system in accordance with embodiments of the present invention;

FIG. 2 is a high level flowchart illustrating non-limiting exemplary method in accordance with embodiments of the present invention;

FIG. 3 is a high level flowchart illustrating non-limiting exemplary method in accordance with embodiments of the present invention; and

FIG. 4 is a block diagram illustrating non-limiting exemplary architecture of a system in accordance with embodiments of the present invention; and

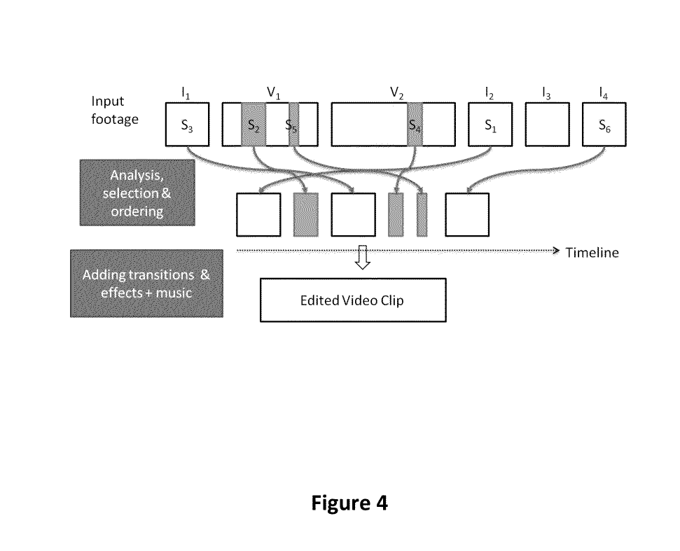

FIG. 5 is a block diagram illustrating non-limiting exemplary architecture of a system in accordance with embodiments of the present invention.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

A major bottleneck in editing photos and videos on the cloud is transferring the user's footage from the user's personal device (or any place in which this footage is being kept or captured) to the cloud server on which the processing is done. This transfer operation is usually referred to as “uploading”.

In selective upload, only portions of the user-footage that are necessary for the editing are uploaded (or transferred). Methods for determining these portions are described in the next sections.

Formally, given a video V, the selective upload can be determined using a function

fᵥ(x,y,t)->{0,1}. (1)

The function defines for each video voxel (x,y,t) in the video V whether to upload this pixel or not. Practically, we will usually determine only time-segments of the video to be uploaded, i.e.: fv(t)->{0,1}.

This binary decision can be generalized to a function which determines the quality in which each portion of the video will be transferred: fv(t)->[0,1], where 1 means the original quality, 0 means do not upload this portion at all, and intermediate values 1>x>0 denote some lower quality. Reducing the quality (and, thus, the size) of videos can be done using various well-known video sub-sampling and compression algorithms (denoted sometimes as “video transcoding”), and the quality of the result can be determined based on the resolution of the transcoded video or the bitrate of the compression.

For a given photo I, the selective upload can be determined using a spatial function:

fI(x,y)->[0,1]. (2)

The function defines the quality for each pixel in the photo I. Practically, we will usually not use a different quality for each pixel, but rather a single quality per photo, together with an optional set of rectangles (regions of interest) having a higher quality. Similar to videos, images can be sub-sampled to a lower-resolution, or compressed using various compression parameters that effects the final quality, e.g., via the quality parameter of the jpeg compression.

Given a set of photos and videos S, we thus can set an upload quality function for each video and photo in this set:

f(S)={f(s) for each s∈S} where f(s) is defined as in Eq. (1-2). (3)

### Automatic Selection & Zooming

A special case of the selective upload is when the pre-analysis determines the images and video portions that will be uploaded, together with the zooming of each selected region (which can also be referred as an ROI—region of interest). In this case, the selection parameters are:
The image indices being selected.
The video moments being selected.
A rectangle (ROI) for each image and for each video portion.
Only the area inside the selected ROI of the selection portions will be uploaded.

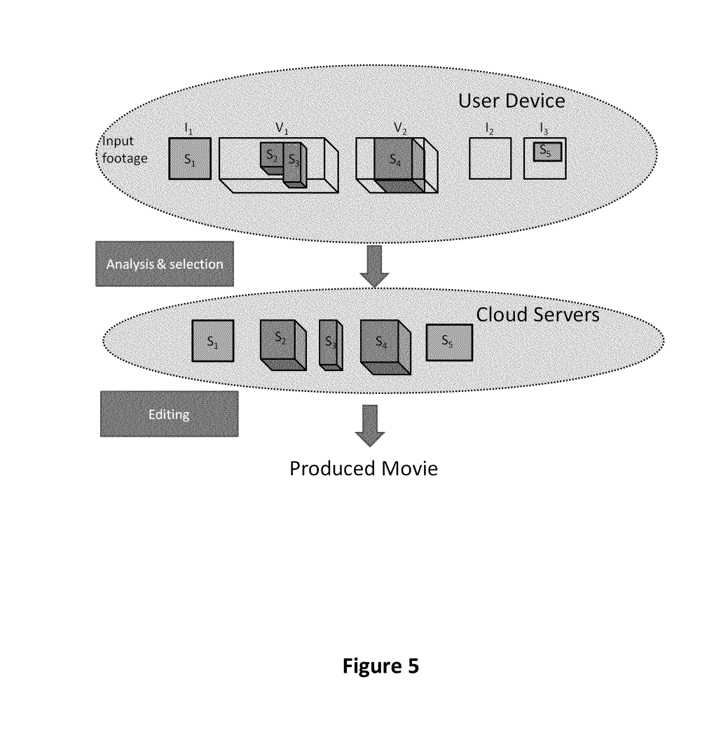

FIG. 5 demonstrates this idea—The selected ROI from selected photos and video portions are uploaded to the cloud and used for producing the edited movie.

### The Selection Score

The automatic selection of the portions to be uploaded to the server can be done by computing a selection score for each portion of the raw footage and uploading the portions for which this score exceeds a pre-defined threshold, or alternatively selecting the best footage that accumulates to a pre-defined quota.

The selection score can include the following components:
Face detection: giving higher score for video frames and photos (or image portions) in which a face was detection.
Person detection—giving preference for detected people.
Saliency—giving preferences for video frames/image portions having high saliency. Omitting boring or repetitive portions.
Omitting video frames for which the camera was shaky or moving.

In general, the selection function should maximize the amount of good footage being uploaded that can be used for editing in the server, while minimizing the total capacity of footage being uploaded.

When the selection includes determining the uploaded ROI, the ROIs will usually be selected to include the important objects or actions in the footage. It may also follow editing criteria that are not directly related to footage quality. For example:
Increasing the variety of the footage (by changing the zooming)
Continuity—not changing the framing too often.
Avoiding Jump-Cuts (if the framing is changed between consecutive portions of the same video, it is better to avoid small changes).

As mentioned in the previous section, the selection can be generalized to determine the quality in which each portion of the footage will be transferred, and not just a binary selection (whether to upload it or not). This quality can be determined based on the selection score—high score will result in uploading this portion at the highest quality, low score will result in zero quality (i.e., the portions with zero quality are not uploaded at all), and portions having intermediate scores will be uploaded with intermediate qualities.

The quality of the different media portions can be determined not only based on the selection score but also based on other criteria, for example, the quality that is needed for further processing or based on the human visual sensitivity. As an example, people are more sensitive to the quality of faces, and thus image regions that consist of faces may be transferred with a higher quality.

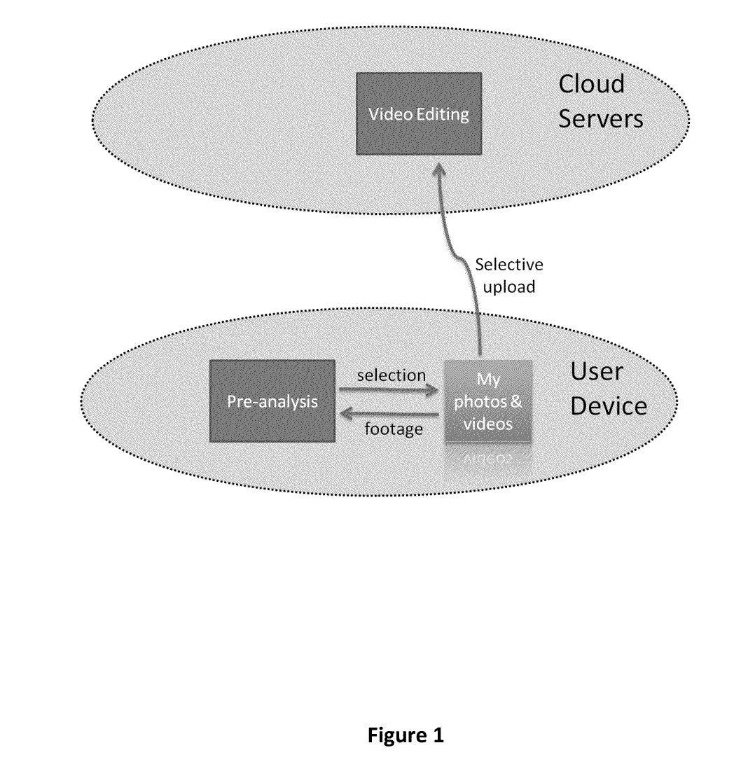

FIG. 1: Selective upload based on pre-analysis on the user device. A pre-analysis step is done in the device, to determine the image and video portions that need to be uploaded to the cloud for further processing. On the cloud, these portions are used as inputs for a videos editing. The video editing may include additional footage analysis, final selection of portions for the editing, adding visual assets such as transitions and effect and finally rendering of the resulting edited video.

Selective Uploaded of User Footage Based on Pre-Analysis on the User Device

One way to select the footage portions to be uploaded for editing is based on a preliminary analysis step on the user device (where the footage is stored or being captured). In this step, good candidates for editing are being selected, while boring or bad portions are omitted. This selection can be done by computing a selection score for each portion of the raw footage, and uploading the portions for which this score exceeds a pre-defined threshold, or alternatively selecting the best footage that accumulates to a pre-defined quota.

This flow is described in FIG. 1.

Selective Upload of User Footage based on a Low-Resolution Preview

A different flow in which a selective uploading of footage can be very useful is in a multiple-pass footage uploading.

In the first pass, the footage is uploaded at a low quality or at a low resolution. These uploaded low-resolution portions can be used to determine the regions to be uploaded at a higher resolution based on two optional flows:

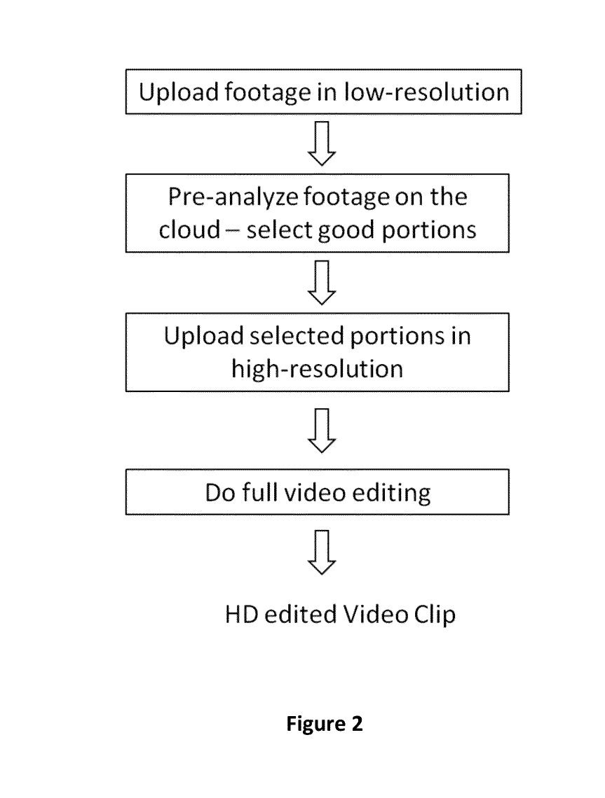

(A) Analyze the footage in the cloud servers and determine the portions that should be uploaded with a higher quality (See FIG. 2).

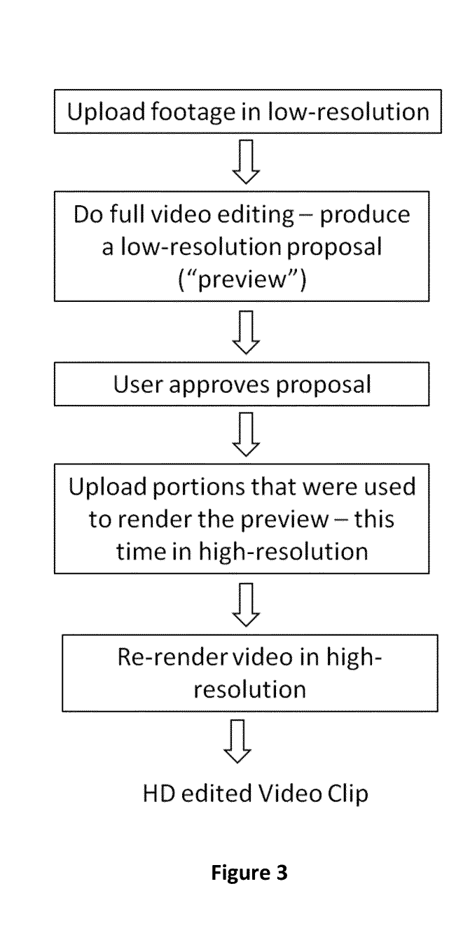

(B) A preview of the edited video is created and shown to the user, and, based on the user satisfaction with the preview, the relevant portions are uploaded again at a higher quality to generate a high-quality version of the preview (See FIG. 3).

More generally, these flows can be considered as a two-passes selective uploading, based on two upload quality functions f1 and f2 as described in equations 1-3, where the processing steps after the first pass f1 are used to determine f2. In some possible implementations, the quality function f2 will always be equal or larger than the quality function f1.

The above two possible flows ((A) pre-analysis and (B) preview) can be combined. First, some portions are selected for upload (in low resolution) using a pre-analysis on the user device. Next, these portions are used for generating a low resolution preview that is shown to the user. If the user approves this preview and requests to get a higher resolution version, the portions that were used for creating the preview (which may be a subset of the portions that were uploaded in the first stage) are uploaded in high-resolution, and an HD video-clip is generated.

FIG. 2: Selective upload based on pre-analysis in low-resolution in the cloud. The footage is first being uploaded in low resolution and being analyzed on the cloud servers (usually, image and video analysis requires a lower resolution than the original one). This pre-analysis is used to determine the portions that should be uploaded at a higher resolution. Finally, a high resolution edited video can be generated from the high-resolution footage being uploaded. It should be noted that whenever we say low-resolution it can always denote ‘low-quality’, e.g., higher compression of the same resolution.

FIG. 3: Selective upload based on a preview: A low-resolution edited video (“preview”) is generated in the cloud using the low-resolution footage. The user views this preview and can decide to request for an HD version of this video. In accordance with the user's request, only the video and image portions that were used for actually generating the preview are uploaded again, this time at a higher resolution, and are used for re-rendering the edited video in a high resolution.

### Application for HD-Quality Video Editing on the Cloud

An important application of selective upload is for HD (High-Definition, which stands here for any high-resolution) video editing on the cloud. As described in the previous section, a preview is generated using a low-resolution footage (that was either selected by the user or automatically). The meta-data that was used to generate this preview is stored (e.g., the selections, visual effects and transitions, instructions for editing, etc.). The generation of this meta-data is demonstrated in Error! Reference source not found. as part of a typical video editing flow: During the video editing, the locations of the selected portions (S1, . . . S6) are calculated, which may be video portions or photos (or photo portions). Additional information (such as effects, transitions, accompanied music, timings, etc.) that were used in the editing is also stored as a meta-data that is attached to the respective user session, in a way that enables to re-render the same video in the future, but with a different (higher) resolution.

The user can now view this low-quality preview and decide whether he wishes to watch (/download) an HD version of this preview. In this case, the selected portions that were used for editing (according to the stored meta-data that is attached to this user session) are being uploaded again at a higher resolution, and combined with the rest of the stored meta-data (mainly transitions and effects) to produce a higher-resolution (e.g., HD) movie.

This flow allows generation of HD movies, while avoiding a full upload of the entire footage. In an extreme case, a few hours of video are edited into a few minutes of video, in which case we save a factor of more than 100 relative to uploading the entire input video.

In order to implement the method according to some embodiments of the present invention, a computer processor may receive instructions and data from a read-only memory or a random access memory or both. At least one of the aforementioned steps is performed by at least one processor associated with a computer. The essential elements of a computer are a processor for executing instructions and one or more memories for storing instructions and data. Generally, a computer will also include, or be operatively coupled to communicate with, one or more mass storage devices for storing data files. Storage modules suitable for tangibly embodying computer program instructions and data include all forms of non-volatile memory, including by way of example semiconductor memory devices, such as EPROM, EEPROM, and flash memory devices and also magneto-optic storage devices.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in base band or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or portion diagrams of methods, apparatus (systems) and computer program products according to embodiments of the invention. It will be understood that each portion of the flowchart illustrations and/or portion diagrams, and combinations of portions in the flowchart illustrations and/or portion diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or portion diagram portion or portions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or portion diagram portion or portions.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or portion diagram portion or portions.

The aforementioned flowchart and diagrams illustrate the architecture, functionality, and operation of possible implementations of systems, methods and computer program products according to various embodiments of the present invention. In this regard, each portion in the flowchart or portion diagrams may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved. It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or ₐₙ element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A method comprising:
obtaining user generated media entities at a mobile device;
analyzing said media entities to derive metadata related to the content of the media entities
automatically selecting a subset of the analyzed media entities based on the derived metadata
uploading said selected subset to a remote server; and
using the uploaded subset at the remote server to generate a video production.

2. The method according to claim 1, wherein the selection of the subset comprises at least one crop operation.

3. The method according to claim 1, wherein the selection of the subset comprises at least temporal video cut operation.

4. The method according to claim 1, wherein said analyzing is carried out at the mobile device.

5. The method according to claim 4, wherein said video production uses said analyzing.

6. The method according to claim 1, wherein said video production utilizes a further analysis carried out at the remote server in addition to the analyzing of the obtained media entities.

7. The method according to claim 1, wherein the analysis is carried out such that the automatically selection is based on detected objects in the user generated media.
